(19) United States
(12) Patent Application Publication
(10) Pub. No.: US 2015/0275748 A1
(43) Pub. Date: Oct. 1, 2015

(54) Rotary Compression Engine

(71) Applicant: Gene Underwood, Simpsonville, SC (US)

(72) Inventor: Gene Underwood, Simpsonville, SC (US)

(21) Appl. No.: 14/669,758

(22) Filed: Mar. 26, 2015

Related U.S. Application Data
(60) Provisional application No. 61/973,058, filed on Mar. 31, 2014.

(51) Int. Cl. F02B 55/02; F02B 55/16; F02B 55/08; F02B 55/14; F02B 53/12; F02B 53/10

(52) U.S. Cl. CPC F02B 55/02; F02B 53/12; F02B 53/10; F02B 55/08; F02B 55/14; F02B 55/16

(57) ABSTRACT

The present disclosure is directed to a rotary engine having improved performance and efficiency. The rotary engine includes one or more rotary engines modules. Each of the modules includes a housing having an internal cavity defined by interior wall, a crankshaft rotatably mounted within the internal cavity of the housing, and a piston having first and second piston members rotatably mounted to opposing sides of the crankshaft. Further, each of the first and second piston members have an exterior side surface, wherein a profile of the exterior side surfaces of the first and second piston members corresponds to a profile of the interior wall. In addition, during operation, the first and second piston members rotate in a first direction around the crankshaft within the housing and engage the interior wall of the internal cavity.

### PRIORITY CLAIM

The present application claims priority to U.S. Provisional Application Ser. No. 61/973,058, filed Mar. 31, 2014.

### FIELD OF THE INVENTION

The present disclosure relates generally to engines, and more particularly to rotary compression engines or pumps configured to provide improved performance and efficiency.

### BACKGROUND OF THE INVENTION

An internal combustion engine (ICE) is an engine where the combustion of a fuel occurs with an oxidizer (usually air) in a combustion chamber that is an integral part of the working fluid flow circuit. In a typical ICE, the expansion of high-temperature and high-pressure gases from the combustion chamber applies direct force to certain components of the engine, e.g. pistons, turbine blades, and/or nozzles. As such, the force moves the component(s) over a distance, transforming chemical energy into useful mechanical energy.

Existing internal combustion engines, however, have limitations on product design, performance, and efficiency. In particular, ICEs generally include bulky components that are not modular, thereby making it difficult to increase the power-to-weight ratio of such engines.

As such, there is a need in the industry for a rotary compression engine that effectively enhances performance and efficiency. Accordingly, the present disclosure is directed to a rotary engine that is compact, lightweight, and modular, thereby providing an improved power-to-weight ratio of the engine.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a rotary engine module configured to enhance performance and efficiency. The rotary engine module includes a housing having an internal cavity defined by interior wall, a crankshaft rotatably mounted within the internal cavity of the housing, and a piston having first and second piston members rotatably mounted to opposing sides of the crankshaft. Further, each of the first and second piston members have an exterior side surface, wherein a profile of the exterior side surfaces of the first and second piston members corresponds to a profile of the interior wall. As such, during operation, the first and second piston members rotate about the crankshaft in a first direction within the housing and engage the interior wall of the internal cavity.

For example, in certain embodiments, the first direction may be a clock-wise direction such that both the first and second piston members rotate together in a clock-wise direction. Alternatively, the first and second piston members may rotate in a counter-clock-wise direction.

In one embodiment, the profile of the exterior side surfaces of the first and second piston members has an arcuate shape. As such, in certain embodiments, the profile of the interior wall may also have an arcuate profile that corresponds to the arcuate shape of the exterior side surfaces of the first and second piston members. Accordingly, the exterior side surfaces of the first and second piston members rotate easily against the corresponding interior wall.

In further embodiments, the first and second piston members are rotatably mounted to opposing ends of the crankshaft via one or more connecting members. In additional embodiments, the first and second piston members may also include one or more piston rings configured with the exterior side surfaces thereof. As such, the piston rings are configured to provide a seal between the first and second piston members and the interior wall of the internal cavity as the piston members rotate within the housing. In certain embodiments, one or more of the piston rings may be configured along a length of the first and second piston members. In additional embodiments, one or more of the piston rings may be configured circumferentially around the first and second piston members.

In another embodiment, the first and second piston members may include one or more depressions on the exterior side surfaces thereof As such, the depressions are configured to provide a predetermined compression displacement ratio as the first and second piston members rotate about the crankshaft.

In additional embodiments, the housing may include a top portion and a bottom portion. More specifically, in certain embodiments, the top and bottom portions may be detachable from each other, which can allow for easy assembly and/or repair of the rotary engine module. In further embodiments, the housing may also include one or more intake ports configured to receive air and/or a fuel, one or more ignition ports configured to secure one or more spark plugs, and/or one or more outlets configured to discharge one or more waste products generated during operation of the rotary engine module. As such, in certain embodiments, the first and second piston members are configured to receive air and fuel through the one or more inlet ports and an ignition source through the one or more ignition ports via the spark plugs so as to ignite the fuel within the piston members.

In another aspect, the present disclosure is directed to a piston for a rotary engine. The piston includes a first piston member configured to be rotatably mounted to a crankshaft of the rotary engine and a second piston member configured to be rotatably mounted to an opposing side of the crankshaft from the first piston member. In addition, each of the first and second piston members includes an exterior side surface having an arcuate cross-sectional shape. As such, the arcuate cross-sectional shape of the exterior side surfaces corresponds to a profile of an interior wall of a housing of the rotary engine. It should be understood that the piston may also include any of the additional features described herein.

In yet another aspect, the present disclosure is directed to a rotary engine assembly. The rotary engine assembly includes a plurality of rotary engine modules. Further, each of the rotary engine modules includes a housing having an internal cavity defined by an interior wall, a crankshaft rotatably mounted within the internal cavity of the housing, and a piston. The piston includes first and second piston members rotatably mounted to opposing sides of the crankshaft. Further, each of the piston members includes an exterior side surface, wherein a profile of the exterior side surfaces of the first and second piston members corresponds to a profile of the interior wall. As such, during operation, the first and second piston members rotate in a first direction around the crankshaft within the housing and engage the interior wall of the internal cavity. It should be understood that the rotary engine assembly may also include any of the additional features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a rotary engine module according to the present disclosure;

FIG. 2 illustrates an exploded, perspective view of one embodiment of a rotary engine module according to the present disclosure, particularly illustrating various internal components of the rotary engine module;

FIG. 3 illustrates another exploded, perspective view of one embodiment of a rotary engine module according to the present disclosure;

FIG. 4 illustrates a top view of one embodiment of a rotary engine module according to the present disclosure;

FIG. 5 illustrates a cross-sectional view of the rotary engine module of FIG. 4 along line 5-5;

FIG. 6 illustrates an end view of the rotary engine module of FIG. 4;

FIG. 7 illustrates various views of one embodiment of a piston member of a rotary engine module according to the present disclosure, particularly illustrating a plurality of piston rings configured thereon; and

FIG. 8 illustrates a flow diagram of one embodiment of various stages of a rotary engine module according to the present disclosure, particularly illustrating the piston members as they rotate about the crankshaft.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

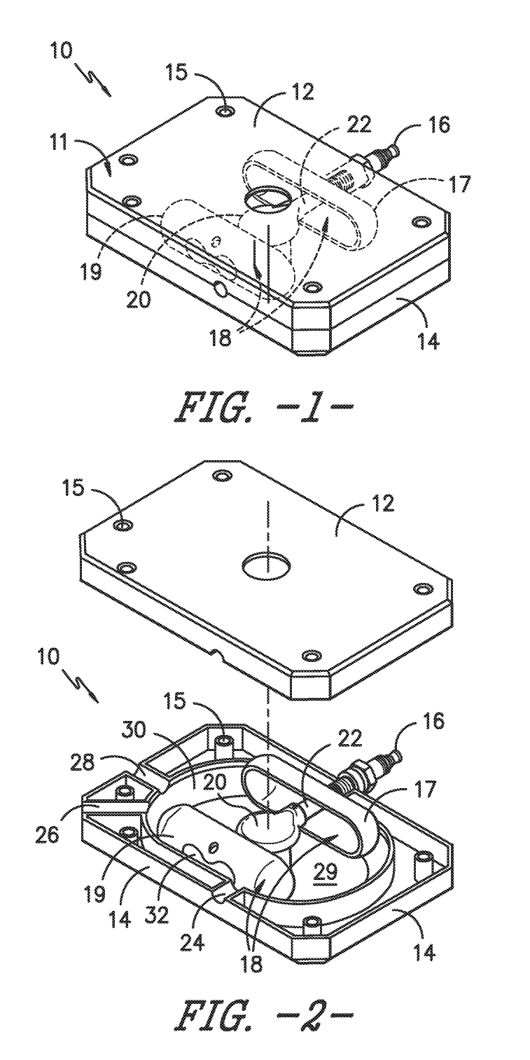

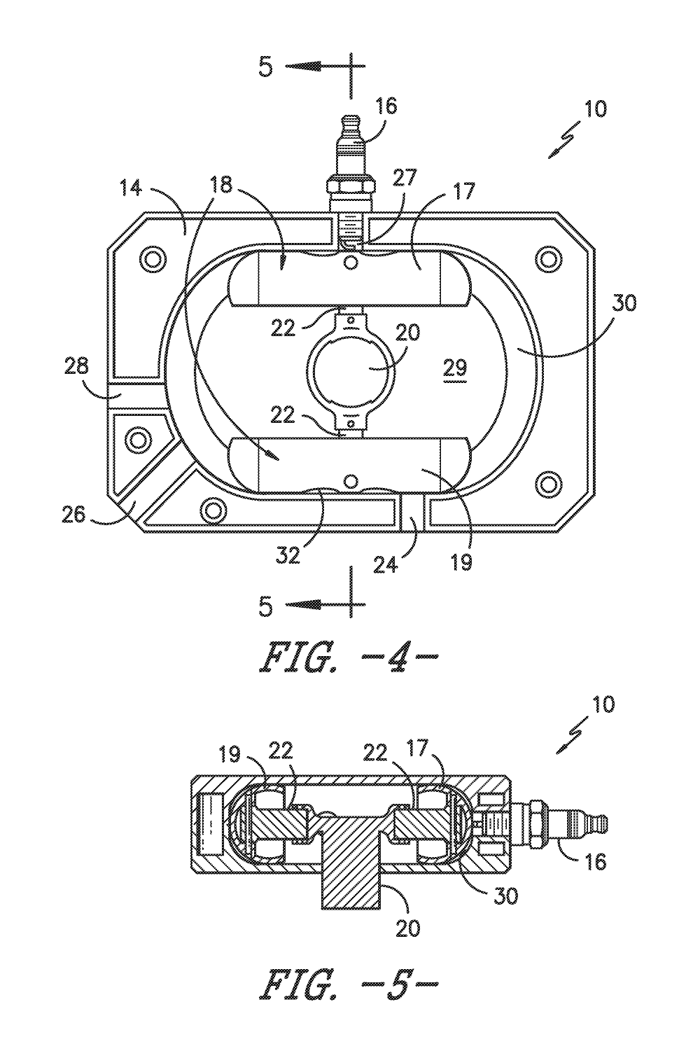

Generally, the present disclosure is directed to a rotary engine assembly having improved performance and efficiency. The rotary engine assembly includes one or more rotary engine modules. For example, as shown generally in FIGS. 1-6, various views of one embodiment of a rotary engine module 10 according to the present disclosure are illustrated. As shown, the rotary engine module 10 includes a housing 11 having an internal cavity 29 defined by interior wall 30, a crankshaft 20 rotatably mounted within the internal cavity 29, and a piston 18 having first and second piston members 17, 19 rotatably mounted to opposing sides of the crankshaft 20. More specifically, as shown, the first and second piston members 17, 19 are rotatably mounted to opposing ends of the crankshaft 20 via one or more connecting members 22 or rods that are mounted to the crankshaft 20.

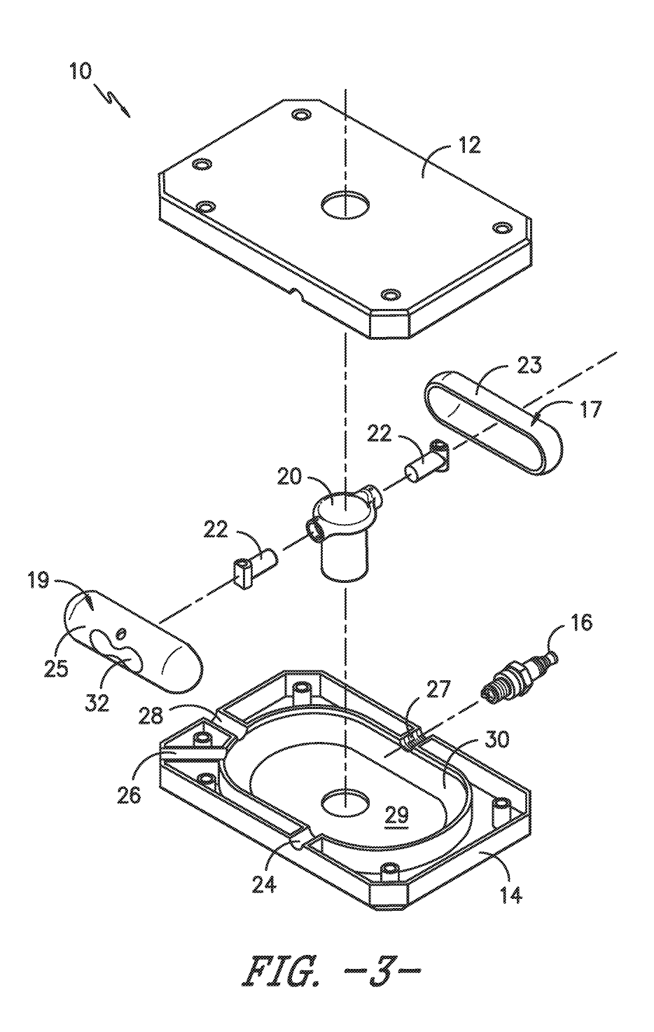

The housing 11 may also include a top portion 12 or casing and a bottom portion 14 or casing. More specifically, in certain embodiments, the top and bottom portions 12, 14 may be detachable from each other, which can allow for easy assembly and/or repair of the rotary engine module 10. Further, in certain embodiments, the crankshaft 20 may be rotatably mounted to or within the bottom portion 14. In additional embodiments, the top and bottom portions 12, 14 may be secured together using any suitable fastening components known in the art, e.g. such as screws, bolts, pins, adhesives, or the like. For example, as shown in FIGS. 1 and 2, the top and bottom portions 12, 14 may be secured together by inserting a plurality of fasteners through through-holes 15. In such embodiments, when the top and bottom portions 12, 14 are arranged together (e.g. FIG. 1), the top and bottom portions 12, 14 form the internal cavity 29 having interior wall 30.

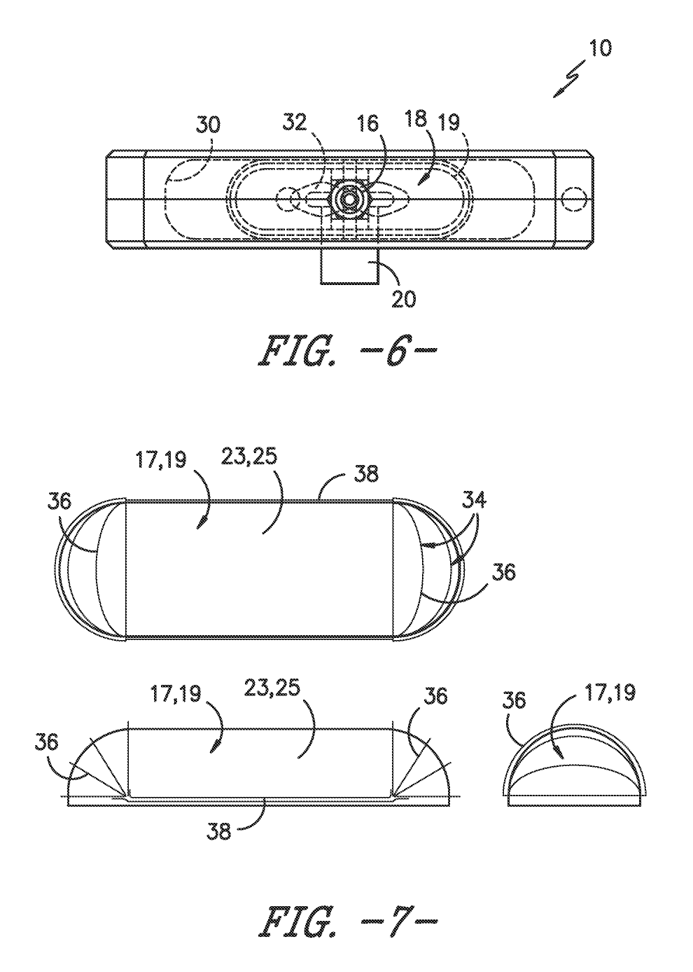

Referring particularly in FIG. 3, each of the first and second piston members 17, 19 have an exterior side surface 23, 25, respectively. More specifically, as shown in FIGS. 5-6, a profile of the exterior side surfaces 23, 25 of the first and second piston members 17, 19 corresponds to a profile of the interior wall 30. For example, as shown in the illustrated embodiment, the exterior side surfaces 23, 25 of the first and second piston members 17, 19 have an arcuate shape. Similarly, as shown, the profile of the interior wall 30 also has an arcuate profile that corresponds to the arcuate shape of the exterior side surfaces 23, 25 of the first and second piston members 17, 19.

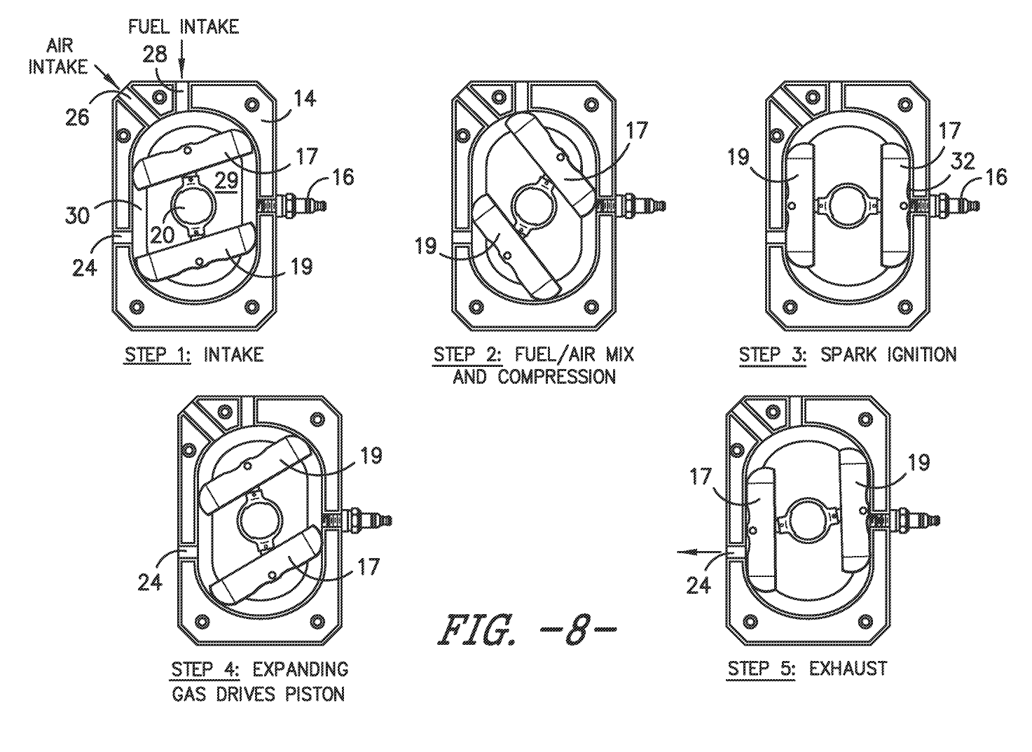

As such, during operation, the corresponding curved surfaces of the first and second piston members 17, 19 engage the curved interior wall 30 of the internal cavity 29 when the piston members 17, 19 rotate around the crankshaft 20. More specifically, as shown in FIG. 7, the first and second piston members 17, 19 may also include one or more piston rings 34 configured with the exterior side surfaces 23, 25 thereof. For example, FIG. 7 illustrates a top view, a side view, and an end view of one embodiment of a piston member 17, 19 so as to illustrate the various piston rings 34 configured thereon. As such, during operation, the piston rings 34 are configured to provide a seal between the first and second piston members 17, 19 and the interior wall 30 of the internal cavity 29 as the piston members 17, 19 rotate within the housing 11. Further, as shown, the piston rings 34 may be configured along a length of the first and second piston members, e.g. longitudinal piston rings 38, or may be configured circumferentially around the first and second piston members, e.g. circumferential piston rings 36. In addition, in certain embodiments, the exterior side surfaces 23, 25 of the piston members 17, 19 may include one or more recesses configured to receive the piston rings therein 34 so as to hold the rings 34 in place.

In certain embodiments, the radius of curvature of the piston members 17, 19 and the interior wall 30 may include any suitable radius so as to optimize engine operation. For example, in certain embodiments, the radius of curvature may be from about one-third (⅓) to about one-half (½) of the length of one of the piston members 17, 19.

Referring to FIGS. 2-4, and 6, the first and second piston members 17, 19 may also include one or more depressions 32 on the exterior side surfaces 23, 25 thereof. As such, the depressions 32 are configured to provide a predetermined compression displacement ratio as the first and second piston members 17, 19 rotate about the crankshaft 20. More specifically, the one or more depressions 32 allow the proper compression displacement ratio from the maximum volume to the minimum volume as the first and second piston members 17, 19 rotate. For example, at the compression/ignition position, the depressions 32 provide sufficient volume between the first and second piston members 17, 19 and the housing 11.

In further embodiments, as shown generally in FIGS. 2-4, the housing 11 may also include one or more intake ports 26, 28 configured to receive air and fuel, one or more ignition ports 27 configured to secure one or more spark plugs 16 within the housing 11, and/or one or more outlets 24 configured to discharge one or more waste products generated during operation of the rotary engine module 10. More specifically, as shown in the illustrated embodiment, the bottom portion 14 of the housing 11 may include an exhaust port 24, an air intake port 26, a fuel injection port 28, and an ignition port 27. It should be understood by those of ordinary skill in the art that any suitable type of fuel injection system may be used with fuel injection port 28. Further, the ignition port 27 is configured to receive a spark plug 16 therein, which may be any suitable spark plug known in the art. Moreover, it should be appreciated that top portion 12 may also include similar ports or openings that correspond to the exhaust port 24, the air intake port 26, and the fuel injection port 28 of the bottom portion 14 such that when the top and bottom portions 12, 14 are secured together, the ports of the top and bottom portions 12, 14 align with each other.

Referring now to FIG. 8, a flow diagram of one embodiment of various stages of the rotary engine module 10 as the piston members 17, 19 rotate about the crankshaft 20 is illustrated. As shown at STEP 1, the first and second piston members 17, 19 are configured to receive air and fuel via the air intake port 26 and the fuel injection port 28. As shown at STEP 2, the fuel and air mixture is compressed by the rotating piston members 17, 19. At STEP 3, the fuel within the piston members 17, 19 is ignited by the spark plug 16 when the piston members 17, 19 are in the ignition/spark position proximate to the spark plug 16. As the fuel ignites, as shown at STEP 4, pressure from expanding gas within the piston members 17, 19 is released, which drives the piston members 17, 19 in a clockwise direction within the internal cavity 29 around the crankshaft 20. As shown at STEP 5, exhaust from the combustion process within the rotary engine module 10 is released through exhaust port 24. The flow diagram illustrated in FIG. 8 may be completed and repeated any number of times. Further, as one piston member 17, 19 completes the cycle of receiving air/fuel, igniting the fuel, and releasing exhaust during the rotation of crankshaft 20, the other piston member 17, 19 completes the same cycle simultaneously. Therefore, both piston members 17, 19 work together to generate power in the rotary engine module 10.

As mentioned, one or more of the rotary engine modules 10 of the present disclosure may be combined to form a rotary engine assembly. More specifically, in certain embodiments, the rotary engine modules 10 may be arranged and secured together, e.g. using an engine block end cap. As such, the rotary engine assembly may include any suitable number and/or arrangement of rotary engine modules 10 up to the point of exceeding the power shaft shear point.

It shall be appreciated that the design of the rotary engine assembly described herein has an improved power-to-weight ratio over prior art engines. Further, the components of the rotary engine module 10 as described herein may include any known materials known in the art and may have any suitable size and/or dimensions. For example, various components of the rotary engine module 10 may be made from metals or metal alloys, including but not limited to stainless steel, aluminum, or similar. In addition, various components of the rotary engine module 10 may be made from non-metals, including but not limited to plastics, rubber, or similar. Further, the rotary engine module 10 may have any suitable dimensions. For example in certain embodiments, the width of the rotary engine module 10 may range from about 50 millimeters (mm) to about 150 mm, the length may range from about 100 mm to about 200 mm, and the height may range from about 20 mm to about 60 mm. As such, in certain embodiments, the rotary engine module may be compact, lightweight, and easy to install. Accordingly, the rotary engine module 10 may be used in any suitable application, for example, that requires a compact volume displacement device such as in automobiles, airplanes, locomotives, industrial engines, air compressors, fluid pumps, or the like.

In additional embodiments, the dimensions described above are not meant to be limiting and it should be understood by those of ordinary skill in the art that dimensions less than or greater than the dimensions described above are also within the spirit and scope of the invention. As such, the rotary engine module 10 may be used in larger engine applications as well. Further, the rotary engine module 10 described herein may be manufactured and/or assembled using any known techniques in the art.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotary engine module, comprising:
a housing comprising an internal cavity, the internal cavity defined by an interior wall;
a crankshaft rotatably mounted within the internal cavity of the housing; and
a piston comprising a first piston member and a second piston member, the first and second piston members rotatably mounted to opposing sides of the crankshaft, each of the first and second piston members comprising an exterior side surface, wherein a profile of the exterior side surfaces of the first and second piston members corresponds to a profile of the interior wall,
wherein, during operation, the first and second piston members rotate around the crankshaft in a first direction within the housing and engage the interior wall of the internal cavity.

2. The rotary engine module of claim 1, wherein the profile of the exterior side surfaces of the first and second piston members comprises an arcuate shape.

3. The rotary engine module of claim 2, wherein the profile of the interior wall comprises an arcuate profile that corresponds to the arcuate shape of the exterior side surfaces of the first and second piston members.

4. The rotary engine module of claim 1, wherein the first and second piston members are rotatably mounted to opposing ends of the crankshaft via one or more connecting members.

5. The rotary engine module of claim 1, wherein the first and second piston members further comprises one or more piston rings configured with the exterior side surfaces thereof, wherein the piston rings are configured to provide a seal between first and second piston members and the interior wall of the internal cavity as the first and second piston members rotate within the housing.

6. The rotary engine module of claim 5, wherein one or more of the piston rings are configured along a length of the first and second piston members or circumferentially about the first and second piston members or both.

7. The rotary engine module of claim 1, wherein the first and second piston members further comprise one or more depressions configured on the exterior side surfaces thereof, the one or more depressions configured to provide a predetermined compression displacement ratio as the first and second piston members rotate about the crankshaft.

8. The rotary engine module of claim 1, wherein the housing further comprises a top portion and a bottom portion, wherein the top and bottom portions are detachable from each other.

9. The rotary engine module of claim 1, wherein the housing further comprises one or more intake ports configured to receive at least one of air or a fuel, one or more ignition ports configured to secure one or more spark plugs, and one or more outlets configured to discharge one or more waste products generated during operation of the rotary engine.

10. The rotary engine module of claim 9, wherein the first and second piston members are configured to receive air and fuel through the one or more inlet ports, and an ignition source through the one or more ignition ports via the spark plugs so as to ignite the fuel within the piston.

11. A piston for a rotary engine, the piston comprising:
a first piston member configured to be rotatably mounted to a crankshaft of the rotary engine; and
a second piston member configured to be rotatably mounted to an opposing side of the crankshaft from the first piston member,
wherein each of the first and second piston members comprises an exterior side surface having an arcuate cross-sectional shape, and wherein the arcuate cross-sectional shape of the exterior side surfaces corresponds to a profile of an interior wall of a housing of the rotary engine.

12. A rotary engine assembly, comprising:
a plurality of rotary engine modules, each of the rotary engine modules comprising:
a housing comprising an internal cavity, the internal cavity defined by an interior wall;
a crankshaft rotatably mounted within the internal cavity of the housing; and
a piston comprising a first piston member and a second piston member, the first and second piston members rotatably mounted to opposing sides of the crankshaft, each of the first and second piston members comprising an exterior side surface, wherein a profile of the exterior side surfaces of the first and second piston members corresponds to a profile of the interior wall,
wherein, during operation, the first and second piston members rotate in a first direction around the crankshaft within the housing and engage the interior wall of the internal cavity.

13. The rotary engine assembly of claim 12, wherein the exterior side surfaces of the first and second piston members comprise an arcuate shape.

14. The rotary engine assembly of claim 13, wherein the profile of the interior wall comprises an arcuate profile that corresponds to the arcuate shape of the exterior side surfaces of the first and second piston members.

15. The rotary engine assembly of claim 12, wherein the first and second piston members are rotatably mounted to opposing ends of the crankshaft via one or more connecting members.

16. The rotary engine assembly of claim 12, wherein the first and second piston members further comprises one or more piston rings configured with the exterior side surfaces thereof, wherein the piston rings are configured to provide a seal between first and second piston members and the interior wall of the internal cavity as the first and second piston members rotate within the housing.

17. The rotary engine assembly of claim 16, wherein one or more of the piston rings are configured along a length of the first and second piston members or circumferentially about the first and second piston members or both.

18. The rotary engine assembly of claim 12, wherein the first and second piston members further comprise one or more depressions configured on the exterior side surfaces thereof, the one or more depressions configured to provide a predetermined compression displacement ratio as the first and second piston members rotate about the crankshaft.

19. The rotary engine assembly of claim 12, wherein the housing further comprises a top portion and a bottom portion, wherein the top and bottom portions are detachable from each other.

20. The rotary engine assembly of claim 12, wherein the housing further comprises one or more intake ports configured to receive at least one of air or a fuel, one or more ignition ports configured to secure one or more spark plugs, and one or more outlets configured to discharge one or more waste products generated during operation of the rotary engine, wherein the first and second piston members are configured to receive air and fuel through the one or more inlet ports, and an ignition source through the one or more ignition ports via the one or more spark plugs so as to ignite the fuel within the piston.
